(19) United States
(12) Patent Application Publication
(10) Pub. No.: US 2018/0209367 A1
(43) Pub. Date: Jul. 26, 2018

(54) MISFIRE DETERMINATION DEVICE FOR INTERNAL COMBUSTION ENGINE

(71) Applicant: TOYOTA JIDOSHA KABUSHIKI KAISHA, Toyota-shi (JP)

(72) Inventors: Hirofumi HASHINOKUCHI, Toyota-shi (JP); Keiichi MYOJO, Okazaki-shi (JP); Yoshiyuki SHOGENJI, Toyota-shi (JP); Yuki NOSE, Kasugai-shi (JP); Eiji IKUTA, Obu-shi (JP)

(73) Assignee: TOYOTA JIDOSHA KABUSHIKI KAISHA, Toyota-shi (JP)

(21) Appl. No.: 15/878,513

(22) Filed: Jan. 24, 2018

(30) Foreign Application Priority Data
Jan. 25, 2017 (JP) 2017-011716

(51) Int. Cl. F02D 41/22; G01M 15/11; G01M 15/10

(52) U.S. Cl. CPC F02D 41/22; F02D 2200/0802; G01M 15/102; G01M 15/11

(57) ABSTRACT

A misfire determination device for an internal combustion engine includes an electronic control unit configured to determine whether execution of temperature rise processing in which a temperature of a catalyst is raised by an air-fuel ratio of one of the cylinders being controlled to be a rich air-fuel ratio lower than a stoichiometric air-fuel ratio and an air-fuel ratio of each of the other cylinders being controlled to be a lean air-fuel ratio higher than the stoichiometric air-fuel ratio is ongoing, determine occurrence of misfire based on whether a rotation variation amount of the internal combustion engine during non-execution of the temperature rise processing exceeds a first misfire determination value, and determine occurrence of misfire based on whether the rotation variation amount during the execution of the temperature rise processing exceeds a second misfire determination value exceeding the first misfire determination value.

### INCORPORATION BY REFERENCE

The disclosure of Japanese Patent Application No. 2017-011716 filed on Jan. 25, 2017 including the specification, drawings and abstract is incorporated herein by reference in its entirety.

### BACKGROUND

### 1. Technical Field

The disclosure relates to a misfire determination device for an internal combustion engine.

### 2. Description of Related Art

Controlling the air-fuel ratio of at least one of a plurality of cylinders of an internal combustion engine to be a rich air-fuel ratio and controlling the air-fuel ratio of each of the other cylinders to be a lean air-fuel ratio is known as temperature rise processing in which the temperature of a catalyst controlling the exhaust gas of the internal combustion engine is raised (refer to, for example, Japanese Unexamined Patent Application Publication No. 2012-057492 (JP 2012-057492 A)).

### SUMMARY

Regarding the internal combustion engine described above, a misfire determination device is known that determines the occurrence or non-occurrence of misfire based on the rotation variation amount of the internal combustion engine. During the execution of the temperature rise processing described above, the rotation variation amount increases because the air-fuel ratios of the cylinders are intentionally controlled to be different from each other. Accordingly, once the misfire determination is made during the execution of the temperature rise processing, an erroneous determination that misfire is ongoing may be made based on a large rotation variation amount regardless of the internal combustion engine being normal. The erroneous determination may result in a decline in the accuracy of the misfire determination.

The disclosure provides a misfire determination device that is capable of suppressing a decline in the accuracy of a misfire determination.

An aspect of the disclosure relates to a misfire determination device for an internal combustion engine. The misfire determination device includes an electronic control unit configured to determine whether or not execution of temperature rise processing in which a temperature of a catalyst controlling exhaust gas from a plurality of cylinders of the internal combustion engine is raised by an air-fuel ratio of at least one of the cylinders being controlled to be a rich air-fuel ratio lower than a stoichiometric air-fuel ratio and an air-fuel ratio of each of the other cylinders being controlled to be a lean air-fuel ratio higher than the stoichiometric air-fuel ratio is ongoing, determine occurrence of misfire based on whether or not a rotation variation amount of the internal combustion engine during non-execution of the temperature rise processing exceeds a first misfire determination value, and determine occurrence of misfire based on whether or not the rotation variation amount during the execution of the temperature rise processing exceeds a second misfire determination value exceeding the first misfire determination value.

According to the aspect of the disclosure, the occurrence of the misfire is determined based on whether or not the rotation variation amount during the execution of the temperature rise processing exceeds the second misfire determination value exceeding the first misfire determination value. Accordingly, an erroneous determination that the misfire is ongoing being made in a normal state can be suppressed during the execution of the temperature rise processing entailing an increase in rotation variation. As a result, a decline in the accuracy of the misfire determination can be suppressed.

In the misfire determination device according to the aspect of the disclosure, the electronic control unit may be configured to determine the occurrence of the misfire based on whether or not the rotation variation amount during the execution of the temperature rise processing corresponding to the cylinder of which the air-fuel ratio is controlled to be the rich air-fuel ratio exceeds the second misfire determination value and determine the occurrence of the misfire based on whether or not the rotation variation amount during the execution of the temperature rise processing corresponding to the cylinder of which the air-fuel ratio is controlled to be the lean air-fuel ratio exceeds the first misfire determination value.

According to the aspect of the disclosure, a misfire determination device for an internal combustion engine with which a decline in the accuracy of a misfire determination is suppressed can be provided.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic configuration diagram of an engine system;

FIG. 2 is a flowchart illustrating an example of misfire determination value change processing executed by an ECU;

FIG. 3 is an example of a timing chart illustrating the switching of a misfire determination value that results from the execution of temperature rise processing;

FIG. 4 is an example of a map defining a determination value depending on an increase/decrease ratio; and

FIG. 5 is a flowchart illustrating a modification example of the misfire determination value change processing.

### DETAILED DESCRIPTION OF EMBODIMENTS

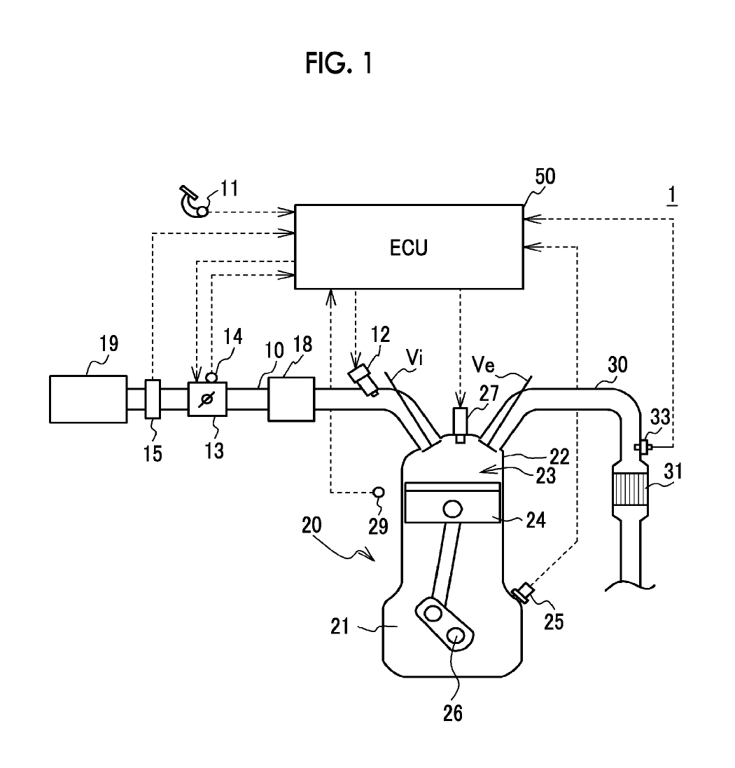

FIG. 1 is a schematic configuration diagram of an engine system 1. In an engine 20, a piston 24 reciprocates as an air-fuel mixture is combusted in a combustion chamber 23 inside a cylinder head 22 installed in the upper portion of a cylinder block 21 storing the piston 24. The reciprocation of the piston 24 is converted into the rotational motion of a crankshaft 26. The engine 20 is an in-line four-cylinder engine. However, the engine 20 is not limited thereto insofar as it has a plurality of cylinders.

An intake valve Vi opening and closing an intake port and an exhaust valve Ve opening and closing an exhaust port are disposed for each cylinder in the cylinder head 22 of the engine 20. An ignition plug 27 for igniting the air-fuel mixture in the combustion chamber 23 is attached for each cylinder to the top portion of the cylinder head 22.

The intake port of each cylinder is connected to a surge tank 18 via a branch pipe for each cylinder. An intake pipe 10 is connected to the upstream side of the surge tank 18. An air cleaner 19 is disposed at the upstream end of the intake pipe 10. On the intake pipe 10, an air flow meter 15 for intake air amount detection and an electronically controlled throttle valve 13 are disposed in this order from the upstream side of the intake pipe 10.

A fuel injection valve 12 for fuel injection into the intake port is installed at the intake port of each cylinder. The fuel that is injected from the fuel injection valve 12 forms the air-fuel mixture by being mixed with intake air. The air-fuel mixture is suctioned into the combustion chamber 23 when the intake valve Vi is opened. Then, the air-fuel mixture is compressed by the piston 24, ignited by the ignition plug 27, and combusted. A fuel injection valve directly injecting a fuel into a cylinder may be disposed in place of the fuel injection valve 12 that injects the fuel into the intake port. Alternatively, both a fuel injection valve that injects a fuel into a cylinder and the fuel injection valve that injects the fuel into the intake port may be provided at the same time.

The exhaust port of each cylinder is connected to an exhaust pipe 30 via a branch pipe for each cylinder. A three-way catalyst 31 is disposed on the exhaust pipe 30. The three-way catalyst 31 has an oxygen storage capacity and removes NOx, HC, and CO. In the three-way catalyst 31, one or a plurality of catalyst layers including a catalyst carrier such as alumina (Al₂O₃) and a catalyst metal carried on the catalyst carrier such as Platinum (Pt), Palladium (Pd), and Rhodium (Rh) is formed on a base material such as Cordierite, a honeycomb substrate in particular. The three-way catalyst 31 is an example of a catalyst controlling the exhaust gas that is discharged from the cylinders of the engine 20. The three-way catalyst 31 may be an oxidation catalyst or a gasoline particulate filter coated with an oxidation catalyst.

An air-fuel ratio sensor 33 for detecting the air-fuel ratio of the exhaust gas is installed on the upstream side of the three-way catalyst 31. The air-fuel ratio sensor 33 is a so-called wide-area air-fuel ratio sensor capable of continuously detecting an air-fuel ratio over a relatively wide range. The air-fuel ratio sensor 33 outputs a signal of a value proportional to the air-fuel ratio.

The engine system 1 is provided with an electronic control unit (ECU) 50. The ECU 50 is provided with a central processing unit (CPU), a random access memory (RAM), a read-only memory (ROM), a storage device, and so on. The ECU 50 controls the engine 20 by executing a program stored in the ROM or the storage device. The ECU 50 is a misfire determination device diagnosing an abnormality of the engine 20 and executes misfire determination value change processing (described later). The misfire determination value change processing is realized by a temperature rise determination unit and a misfire determination unit functionally realized by the CPU, the ROM, and the RAM. Details thereof will be described later.

The ignition plug 27, the throttle valve 13, the fuel injection valve 12, and so on are electrically connected to the ECU 50. In addition, an accelerator operation amount sensor 11 for accelerator operation amount detection, a throttle opening degree sensor 14 detecting the throttle opening degree of the throttle valve 13, the air flow meter 15 for intake air amount detection, the air-fuel ratio sensor 33, a crank angle sensor 25 detecting the crank angle of the crankshaft 26, a coolant temperature sensor 29 detecting the temperature of a coolant for the engine 20, and various other sensors are electrically connected to the ECU 50 via an A/D converter (not illustrated) and so on. The ECU 50 performs ignition timing control, fuel injection amount control, fuel injection ratio control, fuel injection timing control, throttle opening degree control, and so on and controls the ignition plug 27, the throttle valve 13, the fuel injection valve 12, and so on based on the values that are detected by the various sensors and the like so that a desired output is obtained.

Target air-fuel ratio setting by the ECU 50 will be described below. A target air-fuel ratio is set in accordance with the operation state of the engine 20 while temperature rise processing (described later) is not performed. For example, a stoichiometric air-fuel ratio is set as the target air-fuel ratio when the operation state of the engine 20 is in a low-rotation and low-load region and an air-fuel ratio closer to the rich side than the stoichiometric air-fuel ratio is set as the target air-fuel ratio when the operation state of the engine 20 is in a high-rotation and high-load region. Once the target air-fuel ratio is set, feedback control is performed on the amount of fuel injection into each cylinder such that the air-fuel ratio that is detected by the air-fuel ratio sensor 33 corresponds to the target air-fuel ratio.

The ECU 50 executes the temperature rise processing for the temperature of the three-way catalyst 31 to rise up to a predetermined temperature range. During the temperature rise processing, so-called dither control is executed in which the air-fuel ratio of at least one of the cylinders is controlled to be a rich air-fuel ratio lower than the stoichiometric air-fuel ratio and the air-fuel ratio of each of the other cylinders is controlled to be a lean air-fuel ratio higher than the stoichiometric air-fuel ratio. Specifically, the air-fuel ratio control during the temperature rise processing is to control the air-fuel ratio of one of the cylinders to be the rich air-fuel ratio by performing increase correction such that the air-fuel ratio exceeds the fuel injection amount corresponding to the target air-fuel ratio by a predetermined ratio and to control the air-fuel ratio of each of the other cylinders to be the lean air-fuel ratio by performing decrease correction such that the air-fuel ratio falls short of the fuel injection amount corresponding to the target air-fuel ratio by a predetermined ratio. For example, the air-fuel ratio of one of the cylinders is controlled to be the rich air-fuel ratio by an increase correction of 15% with respect to the fuel injection amount corresponding to the target air-fuel ratio and the air-fuel ratio of each of the other three cylinders is controlled to be the lean air-fuel ratio by a decrease correction of 5% with respect to the fuel injection amount corresponding to the target air-fuel ratio. Once the temperature rise processing is executed as described above, the surplus fuel that is discharged from the cylinder set to have the rich air-fuel ratio adheres to the three-way catalyst 31 and is combusted under a lean atmosphere by the exhaust gas discharged from the cylinder set to have the lean air-fuel ratio. The temperature of the three-way catalyst 31 is raised as a result. In the present example, among the cylinders #1 to #4, the cylinder #1 is controlled to be the rich cylinder #1 of which the air fuel ratio is the rich air-fuel ratio and the cylinders #2 to #4 are controlled to be the lean cylinders #2 to #4 each of which the air fuel ratio is the lean air-fuel ratio.

During the temperature rise processing, the average of the air-fuel ratios of all of the cylinders is set to be the stoichiometric air-fuel ratio. However, the average does not necessarily have to be the stoichiometric air-fuel ratio and the average may also be an air-fuel ratio within a predetermined range including the stoichiometric air-fuel ratio at which the temperature of the three-way catalyst 31 is capable of rising up to an activation temperature and a regeneration temperature. For example, the rich air-fuel ratio is set to a value ranging from 9 to 12 and the lean air-fuel ratio is set to a value ranging from 15 to 16. At least one of the cylinders may be set to have the rich air-fuel ratio with the other cylinders set to have the lean air-fuel ratio.

The ECU 50 determines whether or not the engine 20 is in an abnormal state where misfire is ongoing. When misfire occurs in any one of the cylinders, the rotation speed of the crankshaft 26 decreases in the combustion stroke of at least that cylinder. Accordingly, the rotation variation amount of the crankshaft 26 in the combustion stroke of the cylinder where misfire is ongoing becomes larger than the rotation variation amount in the combustion stroke of the other cylinders where no misfire is ongoing. Accordingly, the ECU 50 determines whether or not misfire is ongoing based on the rotation variation amount of the crankshaft 26 calculated based on the value that is detected by the crank angle sensor 25.

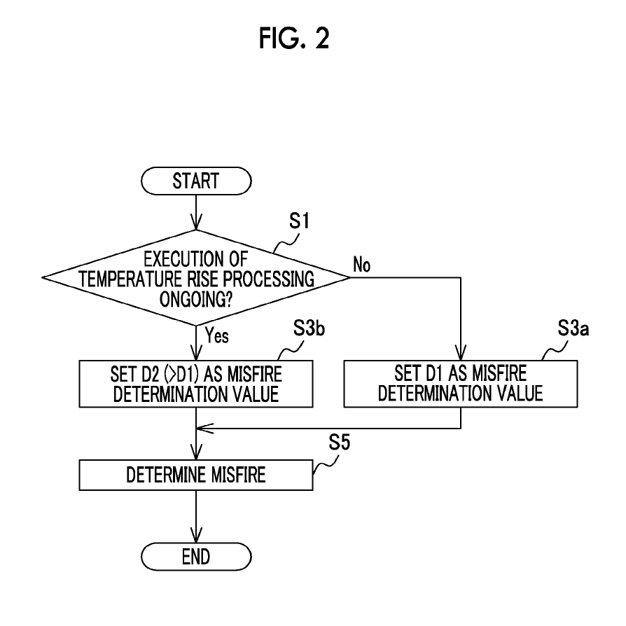

FIG. 2 is a flowchart illustrating an example of the misfire determination value change processing that is executed by the ECU 50. The misfire determination value change processing is repeatedly executed at predetermined cycles.

The ECU 50 determines whether or not the execution of the temperature rise processing is ongoing (Step S1). Specifically, the ECU 50 determines whether or not the execution of the temperature rise processing is ongoing by referring to a temperature rise processing execution flag. A case where the temperature rise processing execution flag is ON means that the execution of the temperature rise processing is ongoing and a case where the temperature rise processing execution flag is OFF means that the execution of the temperature rise processing is not ongoing. The determination of Step S1 is not limited to the method described above. For example, the determination of Step S1 may also be made based on a parameter value that depends on whether or not the execution of the temperature rise processing is ongoing. In a case where the valve opening and closing timing is set to the most advanced angle merely during the execution of the temperature rise processing, for example, the ECU 50 may make the determination of Step S1 by referring to the advance angle amount at the valve opening and closing timing. The processing of Step S1 is an example of the processing that is executed by the temperature rise determination unit determining whether or not the execution of the temperature rise processing is ongoing.

In the case of a negative determination in Step S1, a first determination value D1 (hereinafter, simply referred to as a determination value D1) is set as a misfire determination value (Step S3a). In the case of a positive determination in Step S1, a second determination value D2 (hereinafter, simply referred to as a determination value D2) is set as the misfire determination value (Step S3b). The determination value D2 is set to a value that exceeds the determination value D1.

The ECU 50 determines whether or not the rotation variation amount exceeds the misfire determination value (Step S5). Accordingly, the ECU 50 determines whether or not the rotation variation amount exceeds the determination value D1 during the non-execution of the temperature rise processing and determines whether or not the rotation variation amount exceeds the determination value D2 during the execution of the temperature rise processing. The processing of Step S5 is an example of the processing that is executed by the misfire determination unit determining the occurrence or non-occurrence of misfire based on whether or not the rotation variation amount of the engine 20 during the non-execution of the temperature rise processing exceeds the determination value D1 and determining the occurrence or non-occurrence of misfire based on whether or not the rotation variation amount during the execution of the temperature rise processing exceeds the determination value D2 that exceeds the determination value D1.

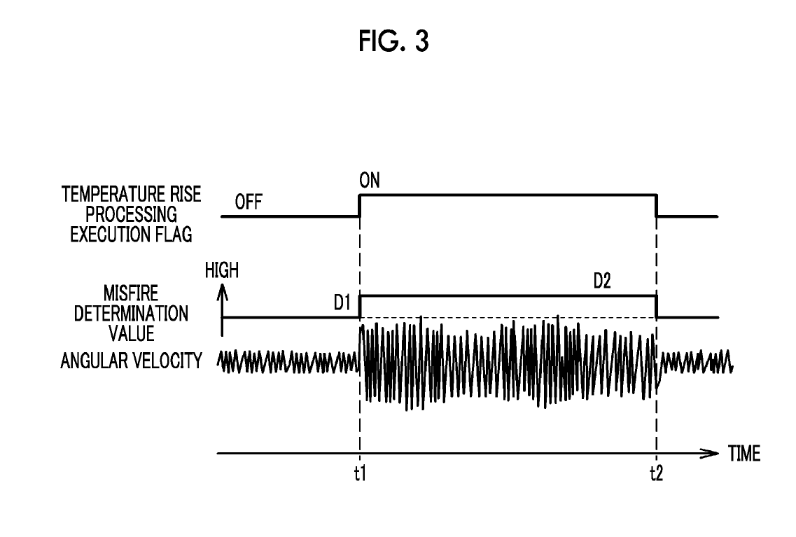

FIG. 3 is an example of a timing chart illustrating the switching of the misfire determination value that results from the execution of the temperature rise processing. The temperature rise processing execution flag, the misfire determination value, and the angular velocity of the crankshaft 26 are illustrated in FIG. 3. Once the temperature rise processing execution flag is switched from OFF to ON at time t1, the temperature rise processing is executed and the rotation variation amount of the crankshaft 26 increases. In other words, the variation of the angular velocity increases as well. Accordingly, the misfire determination value is switched from the determination value D1 to the determination value D2 exceeding the determination value D1 at time t1, at which the execution of the temperature rise processing is initiated. As a result, an erroneous determination that the rotation variation amount exceeds the determination value D1 being made regardless of the engine 20 being normal is prevented during the execution of the temperature rise processing. Once the temperature rise processing is stopped at time t2, the misfire determination value is switched from the determination value D2 to the determination value D1 and the misfire determination is appropriately made even during the non-execution of the temperature rise processing.

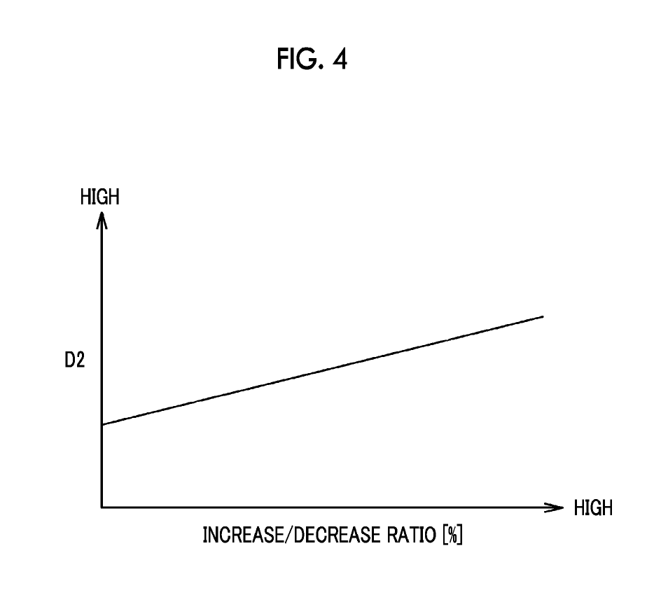

The determination value D2 may be set so as to increase as the increase/decrease ratio of the fuel injection amount during the temperature rise processing increases, that is, as the difference between the rich air-fuel ratio and the lean air-fuel ratio during the temperature rise processing increases. FIG. 4 is an example of a map defining the determination value D2 depending on the increase/decrease ratio. This is because the rotation variation amount increases as the increase/decrease ratio and the difference between the air-fuel ratios increase in a case where the engine 20 is normal. Accordingly, it is effective in a case where the increase/decrease ratio during the temperature rise processing varies with the operation state of the engine 20 or the like. The increase/decrease ratio is the sum of an increase correction ratio and a decrease correction ratio with respect to the fuel injection amount for realizing the rich air-fuel ratio and the lean air-fuel ratio during the temperature rise processing described above. The determination value D2 may also be calculated by a calculation formula without being limited to a map such as the map illustrated in FIG. 4.

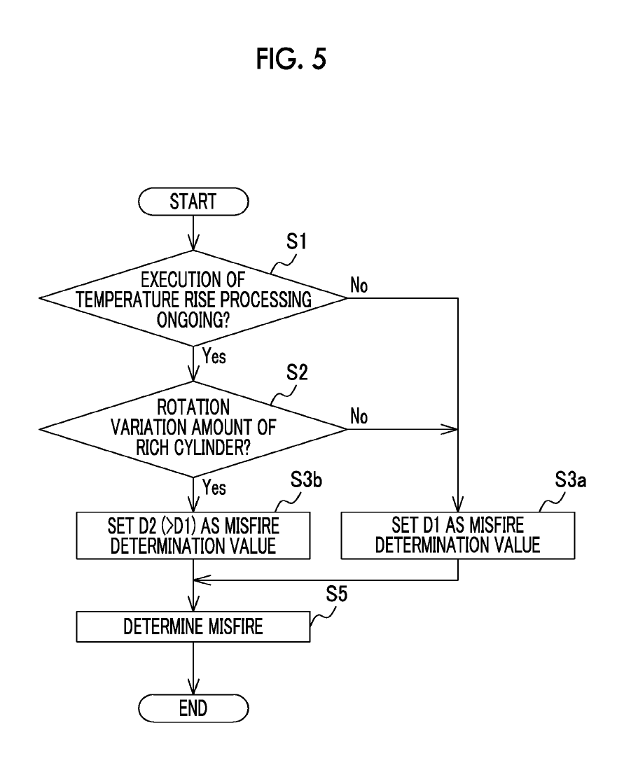

A modification example of the misfire determination value change processing will be described below. FIG. 5 is a flowchart illustrating the modification example of the misfire determination value change processing. In the modification example, the ECU 50 determines whether or not the calculated rotation variation amount is a rotation variation amount corresponding to the rich cylinder #1 (Step S2) in a case where the ECU 50 determines in Step S1 that the execution of the temperature rise processing is ongoing. Specifically, the ECU 50 determines, based on the rotation angle of the crankshaft 26 used for the calculation of the rotation variation amount, whether or not the calculated rotation variation amount is a rotation variation amount corresponding to the rich cylinder #1. In the case of a negative determination in Step S2, the determination value D1 is set to the misfire determination value (Step S3a). In the case of a positive determination in Step S2, the determination value D2 is set to the misfire determination value (Step S3b). In other words, the ECU 50 determines whether or not the rotation variation amount corresponding to the rich cylinder exceeds the determination value D2 and determines whether or not the rotation variation amount corresponding to the lean cylinder controlled to have the lean air-fuel ratio exceeds the determination value D1 (Step S5). A decline in the accuracy of the misfire determination is suppressed as the misfire determination is made based on the determination value D2 for the rotation variation amount corresponding to the rich cylinder #1 in which the rotation variation amount is likely to increase.

The disclosure is not limited to the specific examples that have been described in detail above. The disclosure can be modified and altered in various ways within the scope of the disclosure described in the claims.

As described above, the rich air-fuel ratio and the lean air-fuel ratio are realized by the increase/decrease correction being performed with respect to the fuel injection amount realizing the target air-fuel ratio during the temperature rise processing. However, the disclosure is not limited thereto. In other words, the target air-fuel ratio of any one of the cylinders may be set to the rich air-fuel ratio and the target air-fuel ratios of the other cylinders may directly be set to the lean air-fuel ratio during the temperature rise processing.

What is claimed is:

1. A misfire determination device for an internal combustion engine, the misfire determination device comprising an electronic control unit configured to:
determine whether or not execution of temperature rise processing in which a temperature of a catalyst controlling exhaust gas from a plurality of cylinders of the internal combustion engine is raised by an air-fuel ratio of at least one of the cylinders being controlled to be a rich air-fuel ratio lower than a stoichiometric air-fuel ratio and an air-fuel ratio of each of the other cylinders being controlled to be a lean air-fuel ratio higher than the stoichiometric air-fuel ratio is ongoing,
determine occurrence of misfire based on whether or not a rotation variation amount of the internal combustion engine during non-execution of the temperature rise processing exceeds a first misfire determination value, and
determine occurrence of misfire based on whether or not the rotation variation amount during the execution of the temperature rise processing exceeds a second misfire determination value exceeding the first misfire determination value.

2. The misfire determination device according to claim 1, wherein the electronic control unit is configured to determine the occurrence of the misfire based on whether or not the rotation variation amount during the execution of the temperature rise processing corresponding to the cylinder of which the air-fuel ratio is controlled to be the rich air-fuel ratio exceeds the second misfire determination value and determine the occurrence of the misfire based on whether or not the rotation variation amount during the execution of the temperature rise processing corresponding to the cylinder of which the air-fuel ratio is controlled to be the lean air-fuel ratio exceeds the first misfire determination value.
